(19) United States
(12) Patent Application Publication
(10) Pub. No.: US 2022/0241816 A1
(43) Pub. Date: Aug. 4, 2022

(54) Method Of Repairing Paint Film And Articles Comprising Repaired Paint Film

(71) Applicant: entrotech, inc., Columbus, OH (US)

(72) Inventors: James E. McGuire, Jr., Palm Beach, FL (US); Shane Michael Scott, Hilliard, OH (US)

(73) Assignee: entrotech, inc., Columbus, OH (US)

(21) Appl. No.: 17/619,326

(22) PCT Filed: Aug. 22, 2020
(86) PCT No.: PCT/US2020/047541

§ 371 Date: Dec. 15, 2021

Related U.S. Application Data
(60) Provisional application No. 62/891,193, filed on Aug. 23, 2019.

(51) Int. Cl. B05D 5/00; B05D 3/12; B05D 7/00

(52) U.S. Cl. CPC B05D 5/005; B05D 7/57; B05D 3/12

(57) ABSTRACT

In order to repair any damage to an originally applied paint film, a method of the invention facilitates repair of the paint film by removing essentially only that portion of the paint film that is damaged. After removal of the damaged portion of the paint film, a series of abrading, application, and polishing steps results in a repaired portion of the paint film.

### BACKGROUND OF THE INVENTION

Paint in film form was developed for application to surfaces as an alternative to traditional paint, which traditional paint is typically liquid-based and applied to surfaces in its liquid form—e.g., spray-applied. Paint in film form is based on at least one polymeric layer and can also referred to herein as a “polymeric film” or “polymeric paint film.” An example of such polymeric paint film is described in U.S. Pat. No. 10,035,932, entitled “Paint Replacement Films, Composites Therefrom, and Related Methods.” However, unlike the paint replacement films described therein, many conventional paint film comprises low surface energy material—e.g., fluoropolymers and/or silicone, which can render such paint film resistant to adherence of coatings and other material thereto. See, for example, U.S. Pat. No. 5,965,256. While that resistance can be a benefit when, for example, stain resistance is desired, that resistance can make it difficult to apply desired additional coatings to the paint film after its application to a surface. For example, additional coatings of liquid-based paint could be useful to touch up the paint film in order to conceal imperfections arising based on, for example, wear and tear arising due to use of the article to which the paint film is applied. Due to problems with adherence of such coatings to many conventional paint films, however, methods for successfully repairing paint films once they are applied to a surface have not yet been successfully developed.

### SUMMARY OF THE INVENTION

Although not limited in scope to such paint films, the method of the invention is particularly useful for and facilitates repair of paint films that are essentially free of low surface energy materials. In addition, the method of the invention finds beneficial use for improved efficiency in repair of paint film that is applied to an underlying substrate using an adhesive. Generally, such an underlying substrate is preformed into a desired shape as opposed to, for example, a substrate that is formed in the presence of a paint film that may not otherwise include an adhesive layer.

According to the invention, a method of repairing a paint film originally applied to an underlying substrate using an adhesive comprises sequential steps as follows: removing one or more damaged portions of the paint film from the underlying substrate to expose a damaged area; abrading the paint film adjacent the underlying substrate to which the paint film is no longer uniformly adhered; applying filler to the damaged area and to cover any exposed edges of the adjacent paint film; abrading the outwardly exposed surface of the filler; applying primer to the outwardly exposed surface of the abraded filler and the adjacent paint film; abrading the outwardly exposed surface of the primer; painting the outwardly exposed surface of the abraded primer and the adjacent paint film; abrading the outwardly exposed surface of the paint; applying clear coat to the outwardly exposed surface of the abraded paint; and polishing the outwardly exposed surface of the applied clear coat to form a repaired portion of the paint film, wherein the steps result in a repaired paint film on the underlying substrate.

### BRIEF DESCRIPTION OF THE SEVERAL VIEWS OF THE DRAWINGS

FIG. 1 is a cross-sectional, schematic representation of an exemplary paint film adhered to an underlying substrate, wherein the paint film is shown before damage and repair according to a method of the invention.

FIG. 2A is a cross-sectional, schematic representation of the exemplary paint film adhered to the underlying substrate as shown in FIG. 1, but wherein the paint film is shown to include a damaged area in need of repair.

FIG. 2B is a cross-sectional, schematic representation of the paint film and underlying substrate of FIG. 2A, but wherein the damaged area of the paint film is removed according to a step of the method of the invention.

FIG. 2C is a cross-sectional, schematic representation of the paint film and underlying substrate of FIG. 2B, but wherein the damaged area of the underlying substrate and adjacent paint film are abraded according to a step of the method of the invention.

FIG. 2D is a cross-sectional, schematic representation of the paint film and underlying substrate of FIG. 2C, but wherein a filler is applied to the abraded substrate and adjacent paint film according to a step of the method of the invention.

FIG. 2E is a cross-sectional, schematic representation of the paint film and underlying substrate of FIG. 2D, but wherein the outwardly exposed surface of the filler is abraded according to a step of the method of the invention.

FIG. 2F is a cross-sectional, schematic representation of the paint film and underlying substrate of FIG. 2E, but wherein a primer is applied to the outwardly exposed surface of the abraded filler according to a step of the method of the invention.

FIG. 2G is a cross-sectional, schematic representation of the paint film and underlying substrate of FIG. 2F, but wherein the outwardly exposed surface of the primer is abraded according to a step of the method of the invention.

FIG. 2H is a cross-sectional, schematic representation of the paint film and underlying substrate of FIG. 2G, but a paint is applied to the outwardly exposed surface of the abraded primer according to a step of the method of the invention.

FIG. 2I is a cross-sectional, schematic representation of the paint film and underlying substrate of FIG. 2H, but wherein the outwardly exposed surface of the paint and adjacent paint film are abraded according to a step of the method of the invention.

FIG. 2J is a cross-sectional, schematic representation of the paint film and underlying substrate of FIG. 2I, but wherein a clear coat is applied to the outwardly exposed surface of the abraded paint and adjacent paint film according to a step of the method of the invention.

FIG. 2K is a cross-sectional, schematic representation of the paint film and underlying substrate of FIG. 2J, but wherein the clear coat is polished according to a step of the method of the invention.

### DETAILED DESCRIPTION OF THE INVENTION

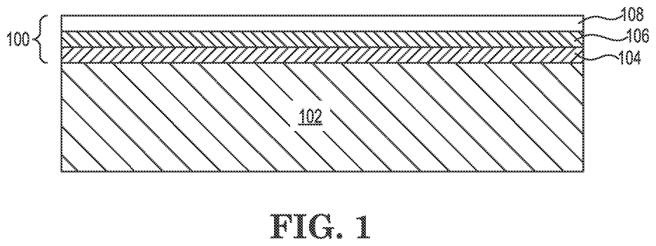

As described in the background, paint film is increasingly being used to apply color to a surface. A paint film generally includes at least an outwardly exposed clear layer (also referred to as a clear coat layer or clearcoat layer) and underlying color layer. The paint film 100 is often adhered to an underlying substrate 102 using an adhesive layer 104, which adhesive layer 104 is on a side of the color layer 106 opposite that of the clear layer 108, as illustrated in FIG. 1.

In order to repair any damage to the paint film, the method of the invention is the first of its kind that allows paint film to be repaired by removing essentially only that portion of the paint film that is damaged. According to the method of the invention, paint film is repaired using a method comprising the below-described steps.

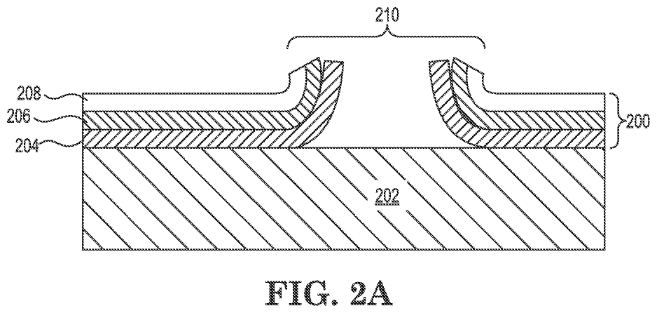

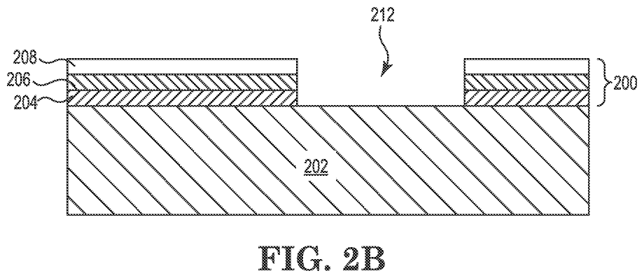

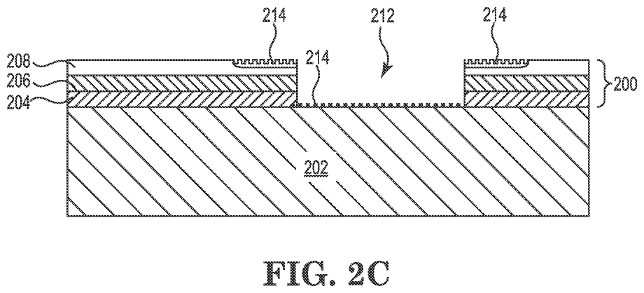

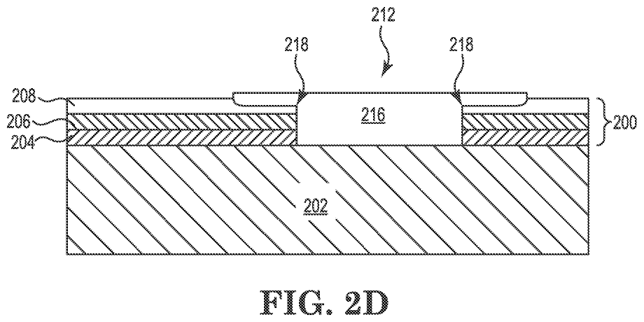

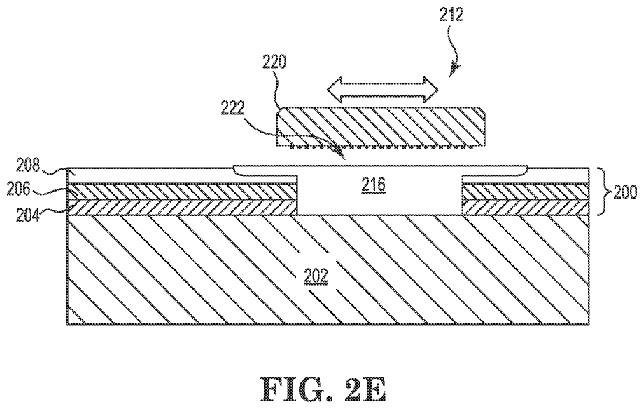

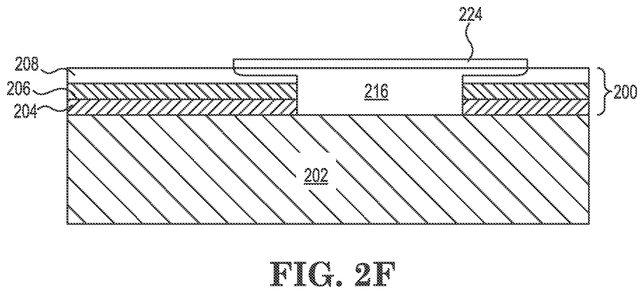

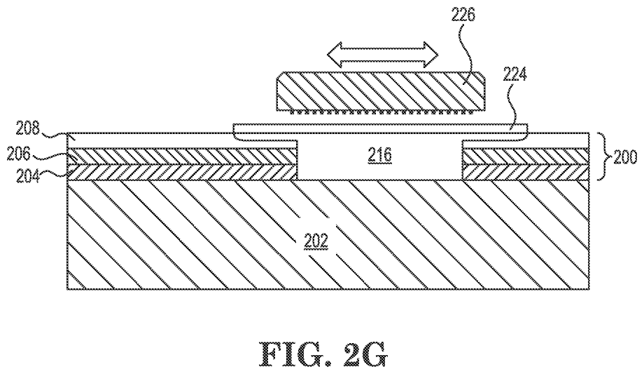

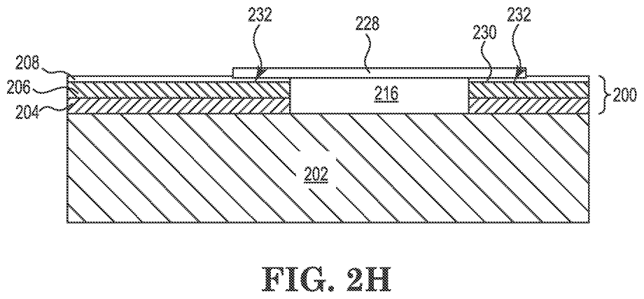

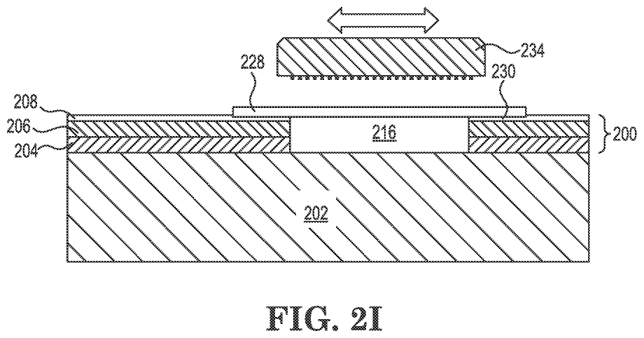

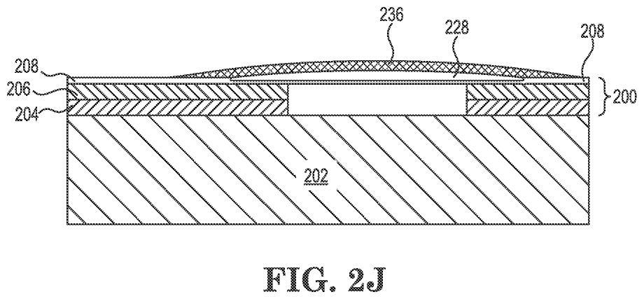

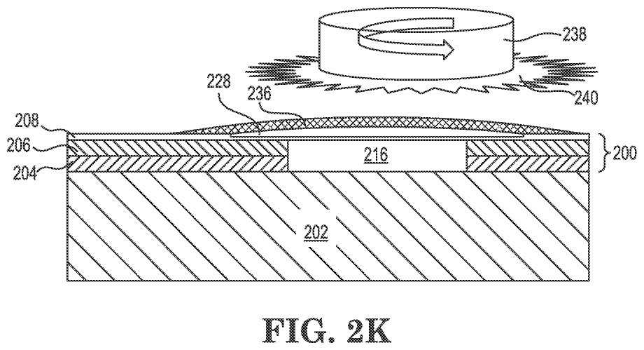

A damaged paint film 200 consisting of an adhesive layer 204, color layer 206, and clear layer 208 is illustrated in FIG. 2A. According to the method, one or more damaged portions 210 of the paint film 200 including any adjacent area of the paint film 200 that may be incidentally included to facilitate repair are first removed from the underlying substrate 202. A paint film 200 with the damaged portion 210 removed is illustrated in FIG. 2B. Damaged portions of paint film 200 can be removed using any suitable mechanism e.g., by cutting with a razor blade or otherwise. Advantageously, the entire sheet of paint film 200 with the damaged portions 210 need not be removed from the surface and discarded when using the method of the invention to repair a paint film surface.

Once the damaged portion 210 is removed, the damaged area 212 (i.e., that portion of the underlying substrate 200 to which the paint film 200 is no longer uniformly adhered) and any adjacent paint film 200 is abraded according to a first abrading step. Any suitable mechanism is used to form abraded surfaces 214, as illustrated in FIG. 2C. In an exemplary embodiment, abrading by sanding is facilitated using a dual action (e.g., random orbit) sander. One example of a useful sander according to the invention is an orbital sander marketed by 3M Company (St. Paul, Minn.) under the 3M™ 20331 trade designation. Any suitable sandpaper can be used for this and other steps of the method of the invention. For example, useful sandpaper is gold and purple sandpaper marketed by 3M Company (St. Paul, Minn.) under the 3M™ Hookit™ trade designation. According to an exemplary aspect of this embodiment, sandpaper having a grit of about 240 is used for this step. Abrading by use of an abrasive pad, in addition to or in lieu of the sandpaper, is performed according to another exemplary embodiment. A wide variety of abrasive pads are known and can be used for this step, including, for example, a red abrasive pad marketed by 3M Company (St. Paul, Minn.) under the SCOTCH-BRITE brand—e.g., Scotch-Brite™ Hand Pad 7447.

After the first abrading step, filler 216 is applied to fill the damaged area 212 and to cover the exposed edge 218 of any adjacent paint film 200, as illustrated in FIG. 2D. Any number of coatings of suitable filler 216 can be applied to reach the desired coverage. In an exemplary embodiment, two to three coats of filler 216 are used for this purpose. A wide variety of suitable filler 216 material is known and can be used for this step, including a self-leveling finishing glaze marketed by 3M Company (St. Paul, Minn.) under the 3M™ Platinum™ Plus Glaze—e.g., 3M part number 31180—and BONDO-brand body filler, also marketed by 3M Company (St. Paul, Minn.).

After the filling step, as illustrated in FIG. 2E, a second abrading step is performed to smooth the filler 216 on the surface 222 of the damaged area 212 and adjacent paint film 200 (e.g., about one-inch to about three-inches of adjacent undamaged paint film 200 is subjected to abrasion according to this second abrading step in one embodiment). In one embodiment, the second abrading step comprises abrading with progressively finer sandpaper 220. Any suitable number and magnitude of sandpaper grits can be used for this second abrading step. In an exemplary embodiment, a progression of 180-grit, 240-grit, 320-grit, and 500-grit, followed by 800-grit, sandpaper 220 is used for this second abrading step.

After the second abrading step, as illustrated in FIG. 2F, at least one coat of primer 224 is applied to the abraded filler 216 and adjacent paint film 200, which was also abraded in that second abrading step. A wide variety of primers 224 are known and can be used for this step, including, for example, 2K-urethane primer-surfacer marketed by The Sherwin-Williams Co. (Warrensville Heights, Ohio) under the P30—SpectraPrime™ trade designation.

After the primer 224 has set up, as illustrated in FIG. 2G, the primer 224 is abraded in a third abrading step using, for example, sandpaper 226 comprising any suitable number and magnitude of sandpaper grits. In an exemplary embodiment, the primer 224 and adjacent paint film 200 (e.g., about one-inch to about three-inches of adjacent undamaged paint film 200 is subjected to abrasion according to this third abrading step in one embodiment) is progressively wet-sanded with 400-grit and 800-grit sandpaper 226.

Next, paint 228 is applied to the abraded primer 230 and adjacent abraded area 232 of the paint film 200, as illustrated in FIG. 2H. In an exemplary embodiment, paint 228 is liquid-applied to the abraded primer 230 and adjacent abraded area 232 according to this step. A wide variety of paints 228 are known and can be used for this step, including, for example, basecoat marketed by PPG Industries Ohio, Inc. (Cleveland, Ohio) under the Deltron™ DBC trade designation (e.g., Deltron™ 2000 DBC). Preferably, the paint 228 is color-matched to the outwardly exposed appearance of the paint film 200, which is primarily driven by the color layer 206. Multiple coats of the paint 228 may be useful to achieve the desired aesthetics and protective properties.

After the paint 228 has dried, as illustrated in FIG. 2I, the paint 228 and adjacent paint film 200 are abraded according to a fourth abrading step (e.g., about one-inch to about three-inches of adjacent undamaged paint film 200 is subjected to abrasion according to this fourth abrading step in one embodiment) is further sanded using a 3,000-grit abrasive 234 (e.g., a 3,000-grit abrasive disc marketed by 3M Company (St. Paul, Minn.) under the 3M™ Trizact™ Hookit™ Foam Abrasive Disc).

Thereafter, as illustrated in FIG. 2J, clear coat 236 is applied over the entire area to which the paint 228 is applied in the preceding step. A wide variety of clear coats 236 are known and can be used for this step, including, for example, clear coat 236 marketed by PPG Industries Ohio, Inc. (Cleveland, Ohio) under the Deltron™ DC trade designation (e.g., Deltron™ DC2000 and Deltron™ DC4000).

Once dried, as illustrated in FIG. 2K, the clear coat 236 is polished using any suitable mechanism to achieve the desired aesthetics and any desired protective properties in a repaired portion of the paint film. In an exemplary embodiment, a wool bonnet 238 and polishing compound 240 are used for this step.

The method of the invention can be used to repair any conventional paint film, including those described in U.S. Pat. No. 10,035,932 and those marketed by entrotech, inc. and its related business entities under the AERO and related brands. The method of the invention is particularly useful in the transportation vehicle industry. For example, the method is beneficially used to repair automotive paint film, particularly paint film installed by an original equipment manufacturer (OEM) on an underlying automobile or other transportation vehicle. According to one aspect of an exemplary embodiment, the repaired portion of the paint film has a gloss value that is within 5 gloss units of a gloss value of the originally applied paint film when tested according to DIN EN ISO 2813. According to another aspect of an exemplary embodiment, the repaired portion of the paint film has color readings having a Delta E of 3 or less when tested according to DIN EN ISO 11664.

Various modifications and alterations of the invention will become apparent to those skilled in the art without departing from the spirit and scope of the invention, which is defined by the accompanying claims. For example, where reference is made to “sandpaper,” understand that any suitable abrasive can be used and need not be in paper form per se. In addition, the lack of mention or discussion of a feature, step, or component provides the basis for claims where the absent feature or component is excluded by way of a proviso or similar claim language.

1. A method of repairing a paint film originally applied to an underlying substrate using an adhesive, comprising sequential steps as follows:
removing one or more damaged portions of the paint film from the underlying substrate to expose a damaged area;
abrading the paint film adjacent the underlying substrate to which the paint film is no longer uniformly adhered;
applying filler to the damaged area and to cover any exposed edges of the adjacent paint film;
abrading the outwardly exposed surface of the filler;
applying primer to the outwardly exposed surface of the abraded filler and the adjacent paint film;
abrading the outwardly exposed surface of the primer;
painting the outwardly exposed surface of the abraded primer and the adjacent paint film;
abrading the outwardly exposed surface of the paint;
applying clear coat to the outwardly exposed surface of the abraded paint; and
polishing the outwardly exposed surface of the applied clear coat to form a repaired portion of the paint film,
wherein the steps result in a repaired paint film on the underlying substrate.

2. The method of claim 1, wherein the underlying substrate is preformed to a desired shape.

3. The method of claim 1, wherein the step of removing one or more damaged portions of the paint film includes removing any adjacent area of the paint film that may be incidentally included to facilitate repair.

4. The method of claim 1, wherein the paint film is essentially free of low surface energy materials.

5. The method of claim 1, wherein the one or more damaged portions of the paint film are removed using a cutting mechanism.

6. The method of claim 1, wherein the entire sheet of paint film with the damaged portions is not removed from the substrate during the method of repairing the paint film.

7. The method of claim 1, wherein any step of abrading comprises sanding using a dual action sander.

8. The method of claim 1, wherein any step of abrading comprises sanding using an orbital sander.

9. The method of claim 1, wherein any step of abrading comprises using an abrasive pad.

10. The method of claim 1, wherein the step of painting comprises applying liquid-applied paint.

11. An article comprising the repaired paint film on the underlying substrate according to the method of claim 1.

12. The article of claim 11, wherein the underlying substrate comprises an exterior surface of a transportation vehicle.

13. The article of claim 11, wherein the repaired portion of the paint film has a gloss value that is within 5 gloss units of a gloss value of the originally applied paint film when tested according to DIN EN ISO 2813.

14. The article of claim 11, wherein the repaired portion of the paint film has color readings having a Delta E of 3 or less when tested according to DIN EN ISO 11664.
